(19) United States
(12) Patent Application Publication
(10) Pub. No.: US 2022/0180430 A1
(43) Pub. Date: Jun. 9, 2022

(54) System and Method of Offering a Loan to Finance Closing Costs

(71) Applicant: Clay Brietz Bethune, Columbia, MO (US)

(72) Inventor: Clay Brietz Bethune, Columbia, MO (US)

(21) Appl. No.: 17/547,074

(22) Filed: Dec. 9, 2021

Related U.S. Application Data
(60) Provisional application No. 63/123,284, filed on Dec. 9, 2020.

(51) Int. Cl. G06Q 40/02

(52) U.S. Cl. CPC G06Q 40/025

(57) ABSTRACT

A method of offering a loan to finance closing costs, such as appraisal fees, credit report fees, inspection fees, title insurance, commissions, points, broker fees, title fees, and more, includes a step of proposing the loan for the closing costs to a potential borrower. While applying for a loan from a financial institution, the potential borrower may also be recommended to apply for financing of the loan for the closing costs. Various credit eligibility information about the potential borrower may be determined, which may be derived from personal financial information obtained at the instance of applying for the loan, such as a credit score, credit history, debt-to-income ratio, and more. Further, the method may include a step of evaluating the personal financial information of the potential borrower. Finally, a user may be approved for the financing of the loan for the closing costs based on the evaluation results.

The current application claims a priority to the U.S. Provisional Patent application Ser. No. 63/123,284 filed on Dec. 9, 2020.

### FIELD OF THE INVENTION

The present invention generally relates to purchasing property. More specifically, the system and method of offering a loan to finance closing costs relates to a method for providing a financing option to fund closing costs on the purchase of residential or commercial properties.

### BACKGROUND OF THE INVENTION

Housing prices have been steadily increasing throughout North America and the world. The change has been so dramatic that many experts believe a shift from individual home ownership to permanently renting from a company or legacy homeowner is going to become the new norm. Residential residences, including single family homes, multiplexes, apartments, condos, and more, are being purchased at increasingly rapid rates. Similarly, commercial properties are being purchased more now than ever before, as real estate in general is expected to continue to rise in value alongside continually-increasing population growth.

The purchasing process for these homes, however, has not experienced meaningful updates. The typical process typically involves, in brief and at a minimum, deciding upon a plot of land and the structures built upon it, obtaining funding through a bank in the form of a mortgage, closing on the property, and finalizing payment of all mediating and service-related parties. It is common within that last step of paying agents, inspectors, contractors, settling with the selling party as applicable, and more to require funding corresponding to a variety of services and post-closure housing costs. Existing methods to facilitate financing of a loan for closing costs are deficient with regard to several aspects. Many existing systems do not provide a standardized service that allows a user to apply for a personal loan to cover all of the closing costs. Moreover, current methods do not strategize on providing flexible plans that may attract more borrowers to apply for different types of loans from the financial institutions mentioned thereof. Therefore, there is a need for improved methods and systems to facilitate financing of the loan for the closing costs that may overcome one or more of the above-mentioned problems and/or limitations.

The present invention addresses these issues. A method of offering a loan to finance closing costs includes a step of proposing the loan for the closing costs to a potential borrower. The potential borrower may apply for at least one type of loan or mortgage from the financial institution. The potential borrower may also be recommended to apply for financing of the loan for the closing costs at an instance of applying for the loan. Various credit eligibility information about the potential borrower may be determined, which may be derived from personal financial information obtained at the instance of applying for the loan, such as a credit score, credit history, debt-to-income ratio, and more. Further, the method may include a step of evaluating the one or more type of information of the potential borrower. Finally, a user may be approved for the financing of the loan for the closing costs based on the evaluation results.

### BRIEF DESCRIPTION OF THE DRAWINGS

FIG. 1 is a block diagram illustrating the system of the present invention.

FIG. 2 is a flowchart illustrating the overall process of the present invention.

FIG. 3 is a continuation of FIG. 2.

FIG. 4 is a flowchart illustrating a subprocess of a lender account receiving a mortgage application.

FIG. 5 is a flowchart illustrating a subprocess of accepting a borrower request for a specific loan amount.

FIG. 6 is a flowchart illustrating a subprocess of enabling referrals between lender accounts.

FIG. 7 is a flowchart illustrating a subprocess of providing identity verification documents.

FIG. 8 is a flowchart illustrating a subprocess of generating and accepting repayment plans.

### DETAILED DESCRIPTION OF THE INVENTION

All illustrations of the drawings are for the purpose of describing selected versions of the present invention and are not intended to limit the scope of the present invention.

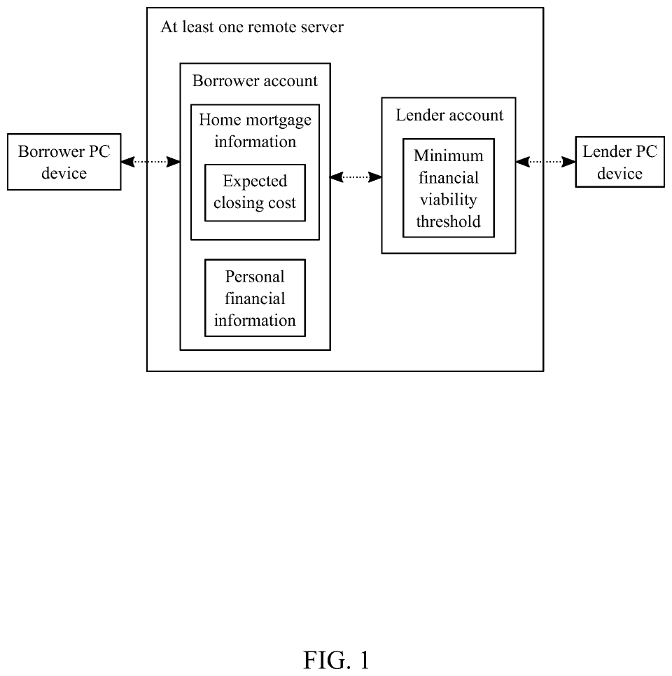

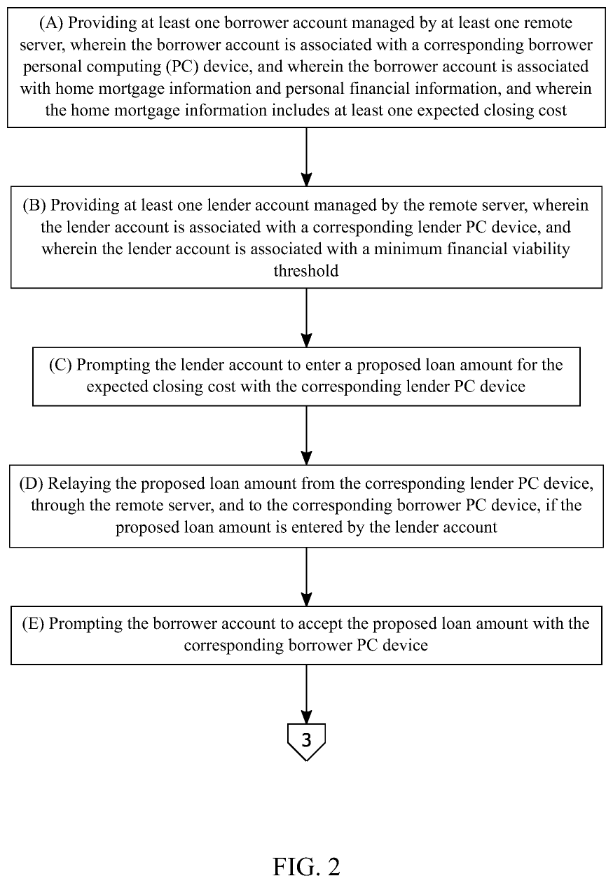

The present invention is a system and method of offering a loan to finance closing costs that allows a borrower to acquire funding for the costs associated with closing on a property. The present invention, as represented in an overview in FIG. 1, accomplishes this by detailing a method that allows lenders to provide such a loan. The system of the present invention includes at least one borrower account managed by at least one remote server, wherein the borrower account is associated with a corresponding borrower personal computing (PC) device, and wherein the borrower account is associated with home mortgage information and personal financial information, and wherein the home mortgage information includes at least one expected closing cost (Step A), as represented in FIG. 2. The borrower account denotes any person or institution wishing to obtain a loan for closing costs upon a desired property. The remote server is a processor or set of processors capable of collecting, storing, manipulating, and distributing data and responses to appropriate remote devices. The corresponding borrower PC device is a smartphone, iPhone, android, laptop, desktop, or other such device capable of allowing a borrower account to connect wirelessly to the Internet. The home mortgage information is a set of information about the property, including, but not limited to, home value, lot value, square footage, zoning information, overall price, and more. The personal financial information relates to a set of information detailing the fiscal situation of the borrower account, potentially including, but not limited to, credit scores, debt-to-income ratio, basic demographics, credit history, banking information, and more that can be used to determine the loan eligibility of the borrower account. The expected closing cost may include appraisal fees, credit report fees, inspection fees, title insurance, commissions, points, broker fees, title fees, and more. Furthermore, at least one lender account managed by the remote server may be provided, wherein the lender account is associated with a corresponding lender PC device, and wherein the lender account is associated with a minimum financial viability threshold (Step B). The lender account may relate to any lending institution, including banks, financial aid institutions, individuals, and more that may be interested in offering a loan for closing costs to the borrower account. The minimum financial viability threshold is the calculated value representing minimum financial requirements that must be met for a borrower account to qualify for a loan for closing costs from the lender account.

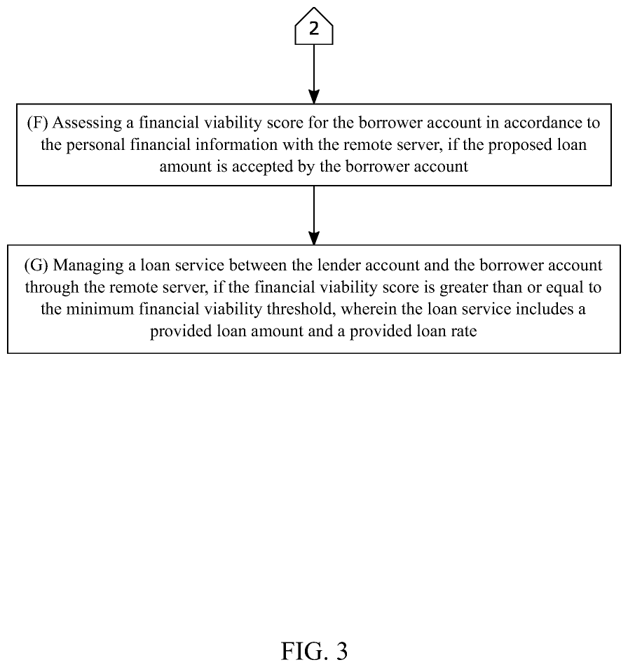

The overall process followed by the method of the present invention allows for effective and efficient generation and offering of a loan for the closing costs associated with buying a property. The lender account is prompted to enter a proposed loan amount for the expected closing cost with the corresponding lender PC device (Step C). The proposed loan amount relates to a calculated, estimated, or otherwise logically determined dollar value that is to be made available as the loan for closing costs. The proposed loan amount is next relayed from the corresponding lender PC device, through the remote server, and to the corresponding borrower PC device, if the proposed loan amount is entered by the lender account (Step D). Thus, the borrower account may view the value of the loan for closing costs that may be offered to the borrower account. In an exemplary embodiment, the borrower account may further be provided with read access to a part, parts, or all of the process of determining the value of the loan available to the borrower. The borrower account may be prompted to accept the proposed loan amount with the corresponding borrower PC device (Step E). This arrangement allows the borrower account to respond after reviewing the proposed loan amount, thereby ensuring that the proposed loan amount is adequate for covering the closing costs as required. A financial viability score for the borrower account is then assessed in accordance to the personal financial information with the remote server, if the proposed loan amount is accepted by the borrower account (Step F), as represented in FIG. 3. The financial viability score represents the available borrowing credit available to the borrower account. The financial viability score could come from a credit bureau, from proprietary underwriting calculations, or from a variety of other sources without violating the scope of this invention. Finally, a loan service is managed between the lender account and the borrower account through the remote server, if the financial viability score is greater than or equal to the minimum financial viability threshold, wherein the loan service includes a provided loan amount and a provided loan rate (Step G). The loan service may interact with the remote server through uploading physical copies of paperwork, may include entirely virtual documentation, or may be a combination of the two. The provided loan amount is the amount of money accepted by, and ultimately transferred to, the borrower account. The provided loan rate is the interest rate, which may accumulate via, simple, compound, or complex interest patterns, which the user owes upon the provided loan amount.

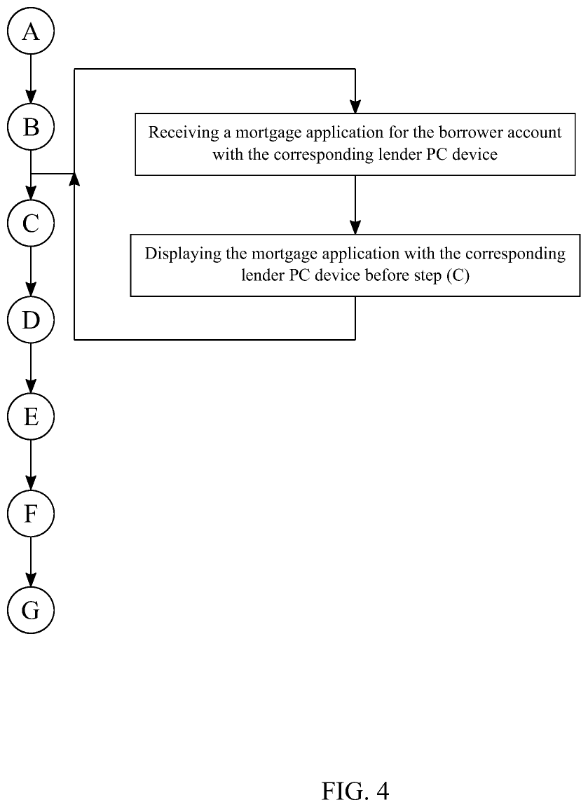

In many cases, the lender account requires visual confirmation of mortgage information before being able to make decisions regarding offering of an acceptable loan. To this end, a mortgage application for the borrower account may be received with the corresponding lender PC device, as represented in FIG. 4. The mortgage application relates to the property information associated with a specific piece of real estate, including pricing information, location information, construction history, and more. The mortgage application may then be displayed with the corresponding lender PC device before Step C. In this way, the corresponding lender PC device may show relevant information to the lender account, thereby enabling the lender account to make decisions regarding loan offerings.

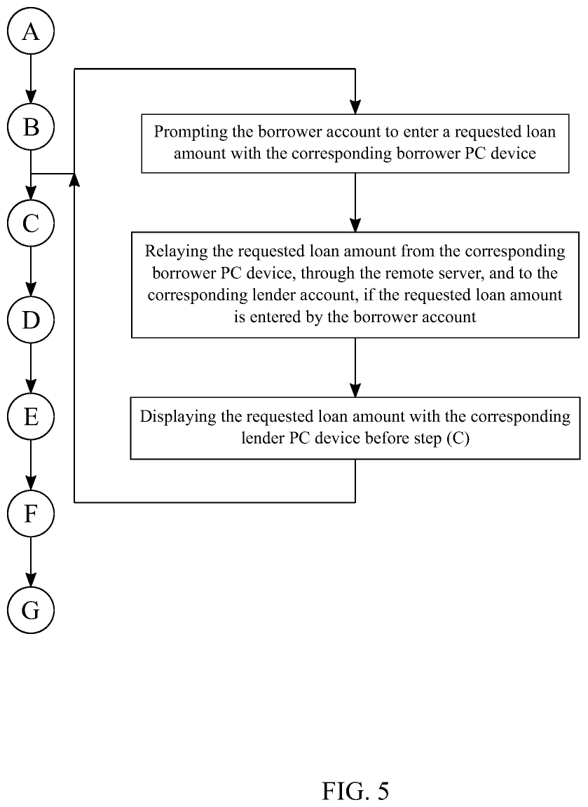

It may further be advantageous to allow the borrower account to request a specific amount of money deemed by the borrower account to be sufficient to cover closing costs. To allow for this, the borrower account may be prompted to enter a requested loan amount with the corresponding borrower PC device, as represented in FIG. 5. The requested loan amount denotes the value desired by the user for the loan for closing costs. The requested loan amount may next be relayed from the corresponding borrower PC device, through the remote server, and to the corresponding lender account, if the requested loan amount is entered by the borrower account. This arrangement enables the remote server to save, store, and appropriately redirect relevant information between the borrower account and the lender account. Subsequently, the requested loan amount may be displayed with the corresponding lender PC device before Step C. In this way, the corresponding lender PC device may show relevant information to the lender account, thereby enabling the lender account to make a loan offering in response to the requested loan amount.

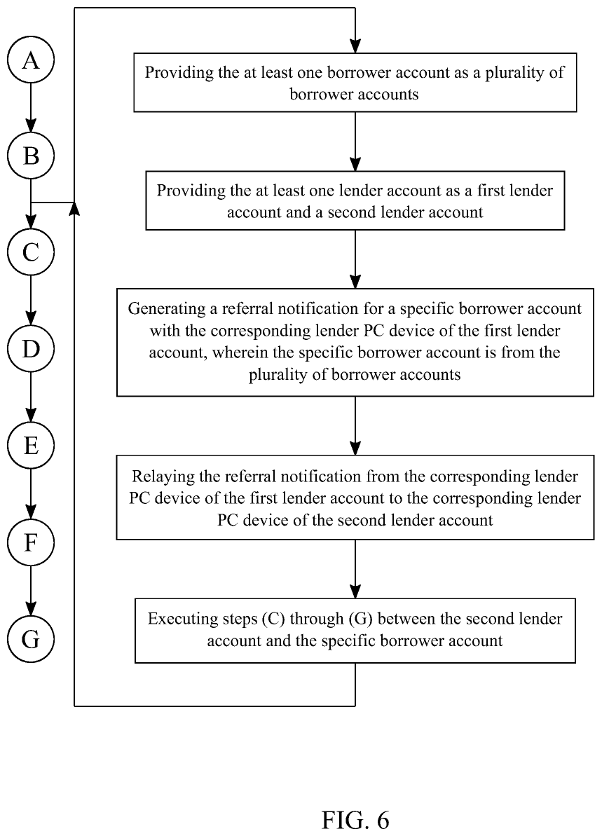

It may be desirable for a given lender account to refer a borrower account to another lender account in order to facilitate lending traffic. To enable this, the at least one borrower account may be provided as a plurality of borrower accounts, as represented in FIG. 6. The plurality of borrower accounts relates to the set of potential borrowers requesting a loan through the remote server. Furthermore, the at least one lender account may be provided as a first lender account and a second lender account. The first lender account represents the lender account that is already associated with a given borrower account from the plurality of borrower accounts. The second lender account refers to the potential reference recipient. A referral notification may be generated for a specific borrower account with the corresponding lender PC device of the first lender account, wherein the specific borrower account is from the plurality of borrower accounts. The specific borrower account may, in some cases, be asked for consent in being referred to another potential lender account. The referral notification may then be relayed from the corresponding lender PC device of the first lender account to the corresponding lender PC device of the second lender account. In this way, the remote server connects the first lender account to the second lender account. Either or both of the first lender account and the second lender account may be individuals, small entities, branches or segments of larger institutions, or other such organizations, not necessarily limited by distance or location. Next, Steps C through G may be executed between the second lender account and the specific borrower account. Thus, the second lender account facilitates financing of the loan for closing costs for the specific borrower account.

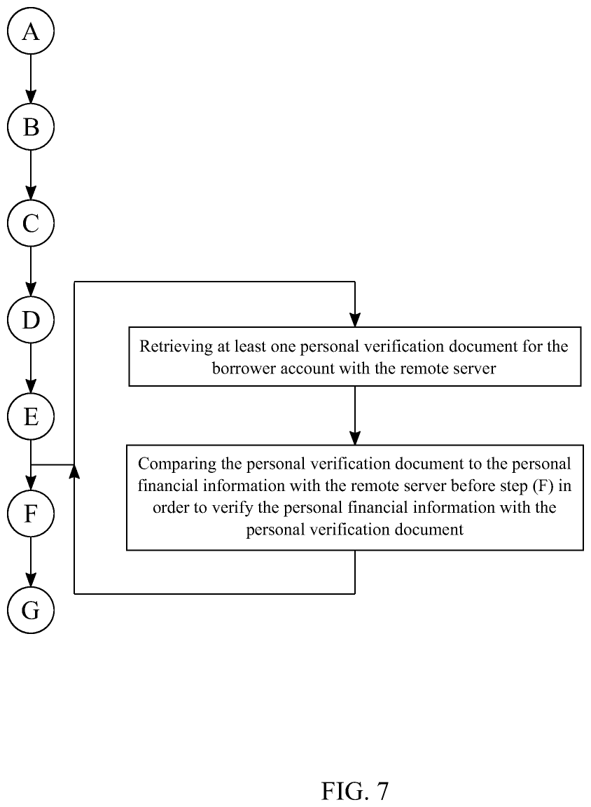

It is common for lender accounts to require or want further information about the borrower account, especially with respect to identity verification, before committing to providing the borrower account with a loan. To this end, at least one personal verification document for the borrower account with the remote server, as represented in FIG. 7. The personal verification document relates to any of identification cards, licenses, passports, birth certificates, bank statements, pay stubs, or other such documentation capable of further affirming the identity of the borrower account, thereby preventing potential fraudulent lending activity. The personal verification document may then be compared to the personal financial information with the remote server before Step F in order to verify the personal financial information with the personal verification document. This arrangement enables the remote server to better verify the identity of the borrower account, thereby facilitating the process of obtaining a loan for closing costs.

Many documents may be desirable as personal verification documents. Specifically, the at least one personal verification document may be selected from a group consisting of: at least one notarized document, at least one proof-of-identification document, at least one proof-of-residence document, at least one proof-of-business document, at least one proof-of-income document, and combinations thereof. Each of the notarized document, the proof-of-identification document, the proof-of-residence document, the proof-of-business document, and the proof-of-income document provides sufficient information to allow the lender account to confidently proceed with the lending process, knowing the necessary relevant information about the borrower account.

The personal financial information must be of sufficient quality to enable a lender account to fully understand the financial position of the borrower account. To this end, the personal financial information may be selected from a group consisting of: a credit score, a credit history, a current income, and a current debt-to-income ratio. The provision of such information is generally a minimum requirement in enabling the lender account to make an educated decision about an appropriate proposed loan amount during Step C.

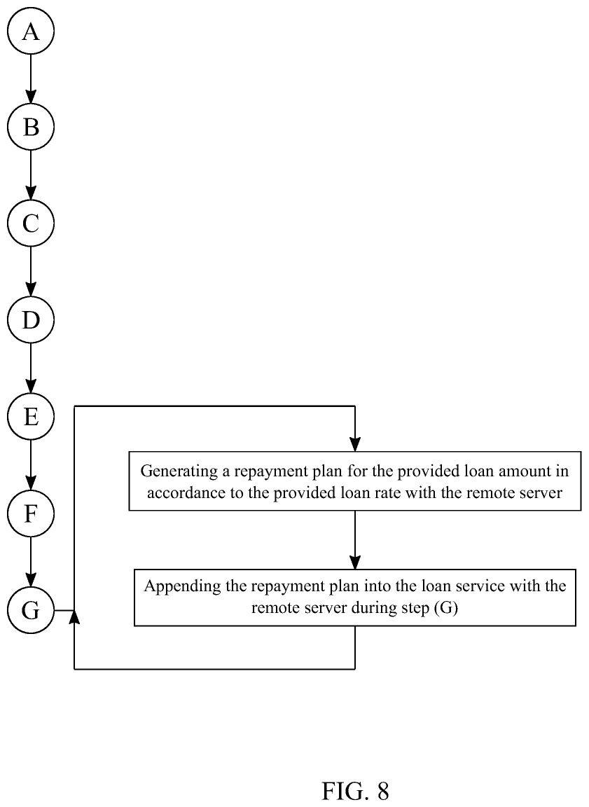

It may be desirable to provide a variety of repayment options to a borrower account in order to accommodate for an unforgiving or inflexible financial situation without prohibiting the borrower account from receiving a loan for closing costs at all. To allow for this, a repayment plan for the provided loan amount may be generated in accordance to the provided loan rate with the remote server, as represented in FIG. 8. The repayment plan may allow the borrower account to pay the provided loan amount and the corresponding interest generated from the provided loan rate at an acceptable pace over a predetermined period of time, such as a number of months or years. The repayment plan may then be appended into the loan service with the remote server during Step G. In this way, a borrower account may repay the provided loan amount principal and interest over time without causing concern for the lender account.

The expected closing cost may cover a variety of different categories of different closing costs. In particular, the expected closing cost may be selected from a group consisting of: at least one appraisal fee, at least one credit report fee, at least one inspection fee, a title insurance fee, at least one commission, at least one point, at least one broker fee, at least one title fee, and combinations thereof. Thus, the expected closing cost may protect a variety of different common closing costs.

Although the invention has been explained in relation to its preferred embodiment, it is to be understood that many other possible modifications and variations can be made without departing from the spirit and scope of the invention as hereinafter claimed.

What is claimed is:

1. A method of offering a loan to finance closing costs, the method comprising the steps of:
(A) providing at least one borrower account managed by at least one remote server, wherein the borrower account is associated with a corresponding borrower PC device, and wherein the borrower account is associated with home mortgage information and personal financial information, and wherein the home mortgage information includes at least one expected closing cost;
(B) providing at least one lender account managed by the remote server, wherein the lender account is associated with a corresponding lender PC device, and wherein the lender account is associated with a minimum financial viability threshold;
(C) prompting the lender account to enter a proposed loan amount for the expected closing cost with the corresponding lender PC device;
(D) relaying the proposed loan amount from the corresponding lender PC device, through the remote server, and to the corresponding borrower PC device, if the proposed loan amount is entered by the lender account;
(E) prompting the borrower account to accept the proposed loan amount with the corresponding borrower PC device;
(F) assessing a financial viability score for the borrower account in accordance to the personal financial information with the remote server, if the proposed loan amount is accepted by the borrower account; and
(G) managing a loan service between the lender account and the borrower account through the remote server, if the financial viability score is greater than or equal to the minimum financial viability threshold, wherein the loan service includes a provided loan amount and a provided loan rate.

2. The method of offering a loan to finance closing costs, the method as claimed in claim 1 comprising the steps of:
receiving a mortgage application for the borrower account with the corresponding lender PC device; and
displaying the mortgage application with the corresponding lender PC device before step (C).

3. The method of offering a loan to finance closing costs, the method as claimed in claim 1 comprising the steps of:
prompting the borrower account to enter a requested loan amount with the corresponding borrower PC device;
relaying the requested loan amount from the corresponding borrower PC device, through the remote server, and to the corresponding lender account, if the requested loan amount is entered by the borrower account; and
displaying the requested loan amount with the corresponding lender PC device before step (C).

4. The method of offering a loan to finance closing costs, the method as claimed in claim 1 comprising the steps of:
providing the at least one borrower account as a plurality of borrower accounts;
providing the at least one lender account as a first lender account and a second lender account;
generating a referral notification for a specific borrower account with the corresponding lender PC device of the first lender account, wherein the specific borrower account is from the plurality of borrower accounts;
relaying the referral notification from the corresponding lender PC device of the first lender account to the corresponding lender PC device of the second lender account; and
executing steps (C) through (G) between the second lender account and the specific borrower account.

5. The method of offering a loan to finance closing costs, the method as claimed in claim 1 comprising the steps of:
retrieving at least one personal verification document for the borrower account with the remote server; and
comparing the personal verification document to the personal financial information with the remote server before step (F) in order to verify the personal financial information with the personal verification document.

6. The method of offering a loan to finance closing costs, the method as claimed in claim 5, wherein the at least one personal verification document is selected from a group consisting of: at least one notarized document, at least one proof-of-identification document, at least one proof-of-residence document, at least one proof-of-business document, at least one proof-of-income document, and combinations thereof.

7. The method of offering a loan to finance closing costs, the method as claimed in claim 1, wherein the personal financial information is selected from a group consisting of: a credit score, a credit history, a current income, and a current debt-to-income ratio.

8. The method of offering a loan to finance closing costs, the method as claimed in claim 1 comprising the steps of:
generating a repayment plan for the provided loan amount in accordance to the provided loan rate with the remote server; and
appending the repayment plan into the loan service with the remote server during step (G).

9. The method of offering a loan to finance closing costs, the method as claimed in claim 1, wherein the expected closing cost is selected from a group consisting of: at least one appraisal fee, at least one credit report fee, at least one inspection fee, a title insurance fee, at least one commission, at least one point, at least one broker fee, at least one title fee, and combinations thereof.
